(19) United States
(12) Patent Application Publication
(10) Pub. No.: US 2013/0191876 A1
(43) Pub. Date: Jul. 25, 2013

(54) REPRODUCING DEVICE, REPRODUCING METHOD, AND PROGRAM

(71) Applicant: SONY CORPORATION, Tokyo (JP)

(72) Inventors: Takuma AOYAMA, Kanagawa (JP); Yoji Kawamoto, Tokyo (JP); Takahira Takenaka, Tokyo (JP)

(73) Assignee: SONY CORPORATION, Tokyo (JP)

(21) Appl. No.: 13/738,269

(22) Filed: Jan. 10, 2013

(30) Foreign Application Priority Data
Jan. 20, 2012 (JP) 2012-009585

(51) Int. Cl. H04N 21/433

(52) U.S. Cl. CPC H04N 21/433
USPC 725/110

(57) ABSTRACT

Disclosed herein is a reproducing device, including: an acquiring portion, a storage control portion and a reproducing portion. The acquiring portion acquires stream data on contents which are streaming-delivered through a network in which a band is changed. The storage control portion controls temporary storage of the stream data thus acquired in an external storage device detachably connected. The reproducing portion reproduces the contents based on the stream data read out from the external storage device.

### BACKGROUND

The present disclosure relates to a reproducing device, a reproducing method, and a program, and more particularly to a reproducing device which is capable of stably reproducing contents, a reproducing method used in the same, and a program used in the same.

In recent years, a service referred to as an Internet Protocol Television (IPT) as a service for delivering digital television broadcastings has been coming into wide use. It is important for the IPTV service to ensure a band of a network. If it may be impossible for the IPTV service to ensure the band of the network, then, the rebuffering is generated. As a result, it may be impossible to smoothly reproduce the contents.

Various kinds of techniques relating to buffer control for preventing such a phenomenon have been proposed. For example, Japanese Patent Laid-Open No. 2010-21867 discloses a technique with which a reference time when stream data temporarily stored in a buffer is reproduced is adjusted in correspondence to a predetermined index value representing a communication situation of a transmission path in a transmission path for which a communication quality is not guaranteed.

### SUMMARY

In addition, when a capacity of an internal buffer which a receiver has is small, it may be impossible to sufficiently absorb the jitter in the network. Thus, a phenomenon in which a video and a sound of the contents which are streaming-delivered are stopped may be frequently generated due to the rebuffering. In particular, when the contents having a High-Definition (HD) image quality are streaming-delivered, the possibility that such a phenomenon is generated is further increased.

As described above, since there is a limit to the capacity of the internal buffer which the receiver has, the capacity of the data which can be buffered depends on the performance of the receiver. For this reason, in the case of the receiver which does not have the internal buffer having the sufficient capacity, it may be impossible to stably reproduce the contents which are streaming-delivered in some cases.

The present disclosure has been made in order to solve the problems described above, and it is therefore desirable to provide a reproducing device which is capable of stably reproducing contents without depending on a communication environment and a performance of a receiver, reproducing method used in the same, and a program used in the same.

In order to attain the desire described above, according to an embodiment of the present disclosure, there is provided a reproducing device including: an acquiring portion acquiring stream data on contents which are streaming-delivered through a network in which a band is changed; a storage control portion controlling temporary storage of the stream data thus acquired in an external storage device detachably connected; and a reproducing portion reproducing the contents based on the stream data read out from the external storage device.

The network means a mechanism which has at least two apparatuses connected thereto, and which is adapted to transmit information from a certain apparatus to another apparatus. The apparatuses which communicate with each other through the network may be the apparatus independent of each other, or may be internal blocks composing one apparatus.

According to another embodiment of the present disclosure, there is provided a reproducing method for use in a reproducing device including: acquiring stream data on contents which are streaming-delivered through a network in which a band is changed by the reproducing device; controlling temporary storage of the stream data thus acquired in an external storage device detachably connected by the reproducing device; and reproducing the contents based on the stream data read out from the external storage device by the reproducing device.

According to still another embodiment of the present disclosure, there is provided a program in accordance with which a computer is caused to function as an acquiring portion acquiring stream data on contents which are streaming-delivered through a network in which a band is changed; a storage control portion controlling temporary storage of the stream data thus acquired in an external storage device detachably connected; and a reproducing portion reproducing the contents based on the stream data read out from the external storage device.

In the reproducing device, the reproducing method, and the program according to the embodiments of the present disclosure, the stream data on the contents which are streaming-delivered through the network in which the band is changed is acquired. The temporary storage of the stream data thus acquired in the external storage device detachably connected is controlled. Also, the contents are reproduced based on the stream data read out from the external storage device.

As set forth hereinabove, according to an embodiment of the present disclosure, it is possible to stably reproduce the contents.

### BRIEF DESCRIPTION OF THE DRAWINGS

FIG. 1 is a block diagram showing a configuration of a contents delivering system to which an embodiment of the present disclosure is applied;

FIG. 2 is a block diagram showing a configuration of apparatuses or devices provided in a service provider shown in FIG. 1;

FIG. 3 is a block diagram showing a configuration of a reproducing device according to an embodiment of the present disclosure;

FIG. 4 is a flow chart explaining contents delivering processing executed in the service provider according to the embodiment of the present disclosure;

FIG. 5 is a flow chart explaining contents reproducing processing executed in the reproducing device according to the embodiment of the present disclosure;

FIG. 6 is a diagram showing an example of a contents list;

FIG. 7 is a flow chart explaining contents reproducing processing when a cache target value is set;

FIG. 8 is a flow chart explaining data deleting processing corresponding to a cache valid period of time; and

FIG. 9 is a block diagram showing a configuration of a computer to which an embodiment of the present disclosure is applied.

### DETAILED DESCRIPTION OF THE PREFERRED EMBODIMENT

An embodiment of the present disclosure will be described in detail hereinafter with reference to the accompanying drawings.

### [Configuration of Contents Delivering System]

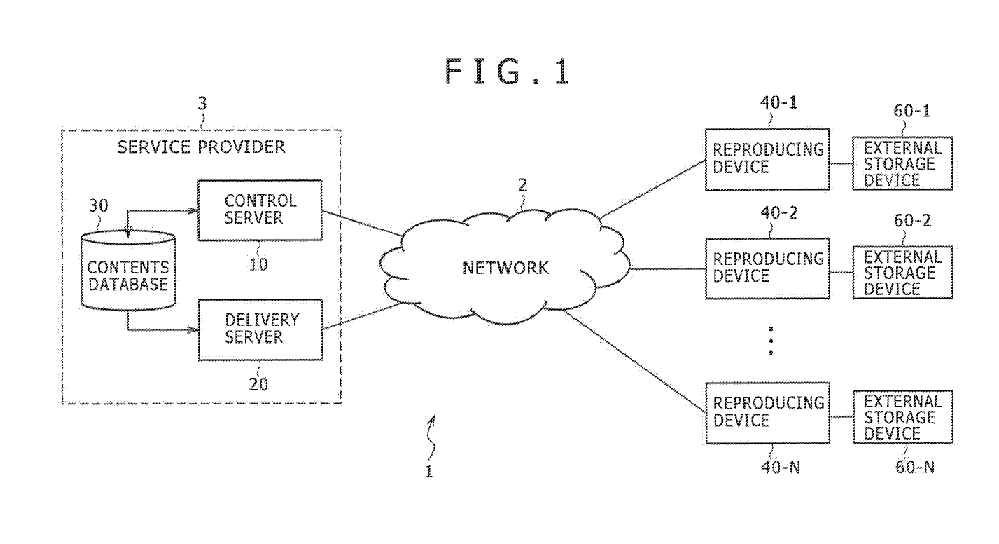

FIG. 1 is a block diagram showing a configuration of a contents delivering system to which an embodiment of the present disclosure is applied.

A contents delivering system 1 is a system for streaming-delivering contents which are provided by a business operator (hereinafter referred to as “a service provider”) which provides a contents delivery service. The contents delivering system 1 is composed of a control server 10, a delivery server 20, a contents database 30, and reproducing devices 40-1 to 40-N (hereinafter simply referred to as “reproducing devices 40” as well).

The control server 10, the delivery server 20, and the reproducing devices 40-1 to 40-N are connected to one another through a network 2. The network 2 is a communication network, such as the Internet, in which a band is changed.

The control server 10, the delivery server 20, and the contents database 30 are all provided by a service provider 3.

The control server 10 manages control information by using the contents database 30. Here, the control information is information in accordance with which temporary storage (cache) of stream data on contents in an external storage device 60 is controlled in streaming reproduction, of the contents, which is carried out in the reproducing device 40.

The control server 10 acquires control information from the contents database 30 in accordance with a request made from the reproducing device 40. The control server 10 transmits the control information thus acquired to the reproducing device 40 through the network 2.

The delivery server 20 acquires the contents from the contents database 30 in accordance with the request made from the reproducing device 40. The delivery server 20 streaming-delivers the contents thus acquired to the reproducing device 40 through the network 2.

The contents database 30 stores therein various kinds of contents which are streaming-delivered with a contents delivery service by the service provider 3. Also, in addition to the data on the contents, the predetermined pieces of control information described above are stored in the contents database 30 so as to be associated with the contents, correspondingly. It is noted that although details will be described later, list generation information which becomes necessary for generating a contents list of various kinds of pieces of metadata or the like is also stored in the contents database 30.

The reproducing device 40-1 requests the control server 10 to supply thereto the control information through the network 2, thereby acquiring the control information supplied from the control server 10. In addition, the reproducing device 40-1 requests the delivery server 20 to deliver thereto the contents through the network 2, thereby streaming-reproducing the contents delivered from the delivery server 20.

The external storage device 60-1 is detachably connected to the reproducing device 40-1. The external storage device 60-1 is a semiconductor memory such as a USE memory which, for example, complies with the Universal Serial Bus (USE) standards. When the external storage device 60-1 is detachably connected to the reproducing device 40-1, the reproducing device 40-1 streaming-reproduces the contents while it utilizes the external storage device 60-1 as a buffer based on the control information acquired from the control server 10.

Each of the reproducing devices 40-2 to 40-N has the same configuration as that of the reproducing device 40-1 described above. Similarly to the case of the reproducing device 40-1, the external storage devices 60-2 to 60-N are detachably connected to the reproducing devices 40-2 to 40-N, respectively, and are utilized as the buffers when the reproducing devices 40-2 to 40-N streaming-reproduce the contents.

The contents delivering system 1 is configured in the manner described above.

### [Configuration of Apparatuses Provided in Service Provider]

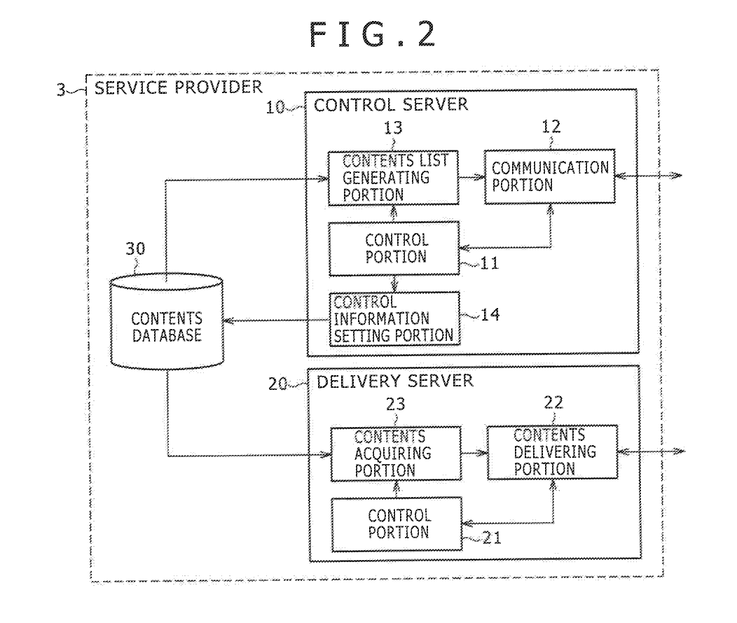

FIG. 2 is a block diagram showing a configuration of apparatuses or devices provided in the service provider 3 shown in FIG. 1.

As shown in FIG. 2, the control server 10, the delivery server 20, and the contents database 30 are provided in the server provider 3.

The control server 10 is composed of a control portion 11, a communication portion 12, a contents list generating portion 13, and a control information setting portion 14.

The control server 11 controls operations of the parts of the control server 10.

The communication portion 12 receives a list request for the contents transmitted thereto from the reproducing device 40, and supplies the list request thus received to the control portion 11 in accordance with the control made by the control portion 11. The control portion 11 controls the generation of the contents list which is carried out in the contents list generating portion 13 in response to the list request made from the communication portion 12.

The contents list generating portion 13 acquires both of list generation information necessary for generating the contents list which can be reproduced in the reproducing device 40, and control information for the contents concerned from the contents database 30 in accordance with the control made by the control portion 11. Also, the contents list generating portion 13 generates the contents list based on both of the list generation information and control information thus acquired, and supplies the contents list thus generated to the communication portion 12.

The control portion 12 transmits the contents list supplied from the contents list generating portion 13 to the reproducing device 40 through the network 2 in accordance with the control made by the control portion 11.

The control information setting portion 14 sets the control information stored in the contents database 30 in accordance with the control made by the control portion 11. For example, when the contents of the control information on the contents which are streaming-delivered are changed in the service provider 3, the control portion 11 updates the contents of the control information stored in the contents database 30 by controlling the control information setting portion 14 in accordance with an instruction issued from a manager.

The control server 10 is configured in the manner as described above.

The delivery server 20 is composed of a control portion 21, a contents delivering portion 22, and a contents acquiring portion 23.

The control portion 21 controls operations of the parts of the delivery server 20.

The contents delivering portion 22 receives a delivery request for the contents transmitted from the reproducing device 40 and supplies the delivery request thus received to the control portion 21. The control portion 21 controls the acquisition of the contents which is carried out in the contents acquiring portion 23 in response to a delivery request from the contents delivering portion 22.

The contents acquiring portion 23 acquires the contents corresponding to the delivery request made from the reproducing device 40 from the contents database 30 in accordance with the control made by the control portion 21, and supplies the contents thus acquired to the contents delivering portion 22.

The contents delivering portion 22 streaming-delivers the contents supplied thereto from the contents acquiring portion 23 to the reproducing device 40 through the network 2 in accordance with the control made by the control portion 21.

The delivery server 20 is configured in the manner as described above.

[configuration of Reproducing Device]

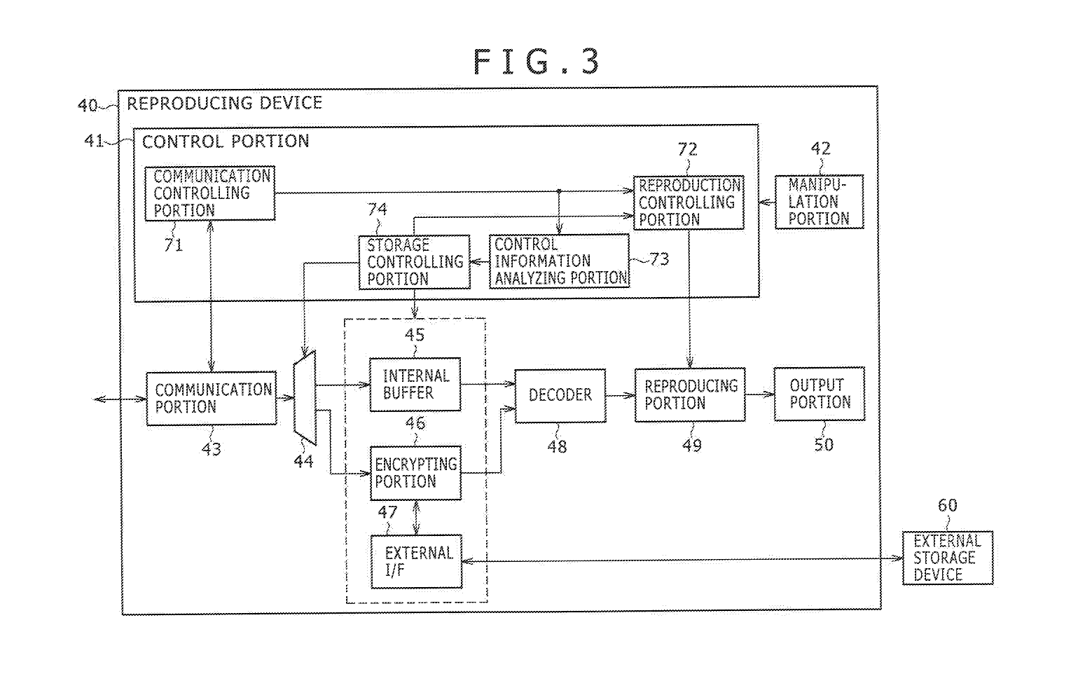

FIG. 3 is a block diagram showing a configuration of the reproducing device 40 according to an embodiment of the present disclosure shown in FIG. 1.

The reproducing device 40 is composed of a control portion 41, a manipulation portion 42, a communication portion 43, a selector 44, an internal buffer 45, an encrypting portion 46, an external I/F 47, a decoder 48, a reproducing portion 49, and an output portion 50.

The control portion 41 controls operations of the parts of the reproducing device 40 in accordance with a manipulation signal or the like supplied thereto from the manipulation portion 42. The control portion 41 is composed of a communication controlling portion 71, a reproduction controlling portion 72, a control information analyzing portion 73, and a storage controlling portion 74.

The communication portion 43 makes a communication with the control server 10 through the network 2 and transmits a list request to the control server 10 in accordance with the control made by the communication controlling portion 71. The communication portion 43 receives the contents list from the control server 10 in response to the list request, and supplies the contents list to the communication controlling portion 71.

The communication controlling portion 71 supplies the contents list transmitted thereto from the communication portion 43 to the reproduction controlling portion 72. Also, the reproduction controlling portion 72 causes the output portion 50 to display thereon the contents list supplied from the communication controlling portion 71 by controlling the reproducing portion 49. In addition, the communication controlling portion 71 supplies the control information contained in the contents list to the control information analyzing portion 73.

When the desired contents are selected from the contents list being displayed on the output portion 50, the communication controlling portion 71 transmits a delivery request for the desired contents to the delivery server 20 by controlling the communication portion 43 in accordance with a manipulation signal supplied thereto from the manipulation portion 42. The communication portion 43 receives stream data on the contents supplied thereto from the delivery server 20 in response to the delivery request, and supplies the stream data thus received to the selector 44.

In addition, the control information analyzing portion 73 acquires and analyzes control information corresponding to the desired contents thus selected from the contents list supplied thereto from the communication controlling portion 71, and supplies the analysis results to the storage controlling portion 74. The storage controlling portion 74 controls operations of the selector 44, the internal buffer 45, the encrypting portion 46, and the external I/F 47 based on the analysis results supplied thereto from the control information analyzing portion 73.

The selector 44 supplies the stream data supplied thereto from the communication portion 43 to either the internal buffer 45 or the encrypting portion 46 in accordance with the control made by the storage controlling portion 74.

When the stream data is supplied from the selector 44 to the encrypting portion 46, the encrypting portion 46 encrypts the stream data based on a predetermined encrypting method in accordance with the control made by the storage controlling portion 74. The encrypting portion 46 outputs the encrypted stream data thus encrypted to the external storage device 60 through the external I/F 47 in accordance with the control made by the storage controlling portion 74. As a result, the stream data on the contents is cached in the external storage device 60.

In addition, the encrypting portion 46 reads out the encrypted stream data cached in the external storage device 60 in accordance with the control made by the storage control portion 74, and decodes the encrypted stream data thus read out in accordance with a predetermined decoding method. The encrypting portion 46 supplies the stream data thus decoded to the decoder 48.

The decoder 48 decodes the stream data supplied thereto from the encrypting portion 46, and the resulting video signal and audio signal thus obtained to the reproducing portion 49.

The reproducing portion 49 outputs the video signal supplied thereto from the decoder 48 to the output portion 50 such as a display device, thereby displaying an image corresponding to the video signal on the output portion 50 in accordance with the control made by the reproduction controlling portion 72. In addition, the reproducing portion 49 outputs the audio signal supplied thereto from the decoder 48 to the output portion 50 such as the speaker, thereby outputting a sound corresponding to the audio signal from the output portion 50. As a result, the streaming reproduction of the contents is carried out in the reproducing device 40.

When the stream data is supplied from the selector 44 to the internal buffer 45, the internal buffer 45 caches therein the stream data in accordance with the control made by the storage controlling portion 74. The stream data cached in the internal buffer 45 is read out at a predetermined timing by the decoder 48 and is then decoded by the decoder 48. Also, similarly to the above case where the data stream data is cached in the external storage device 60, the video corresponding to the video signal, and the sound corresponding to the audio signal are displayed on and outputted from the output portion 50 by the reproducing portion 49.

The reproducing device 40 is configured in the manner as described above.

### [Contents Delivering Processing]

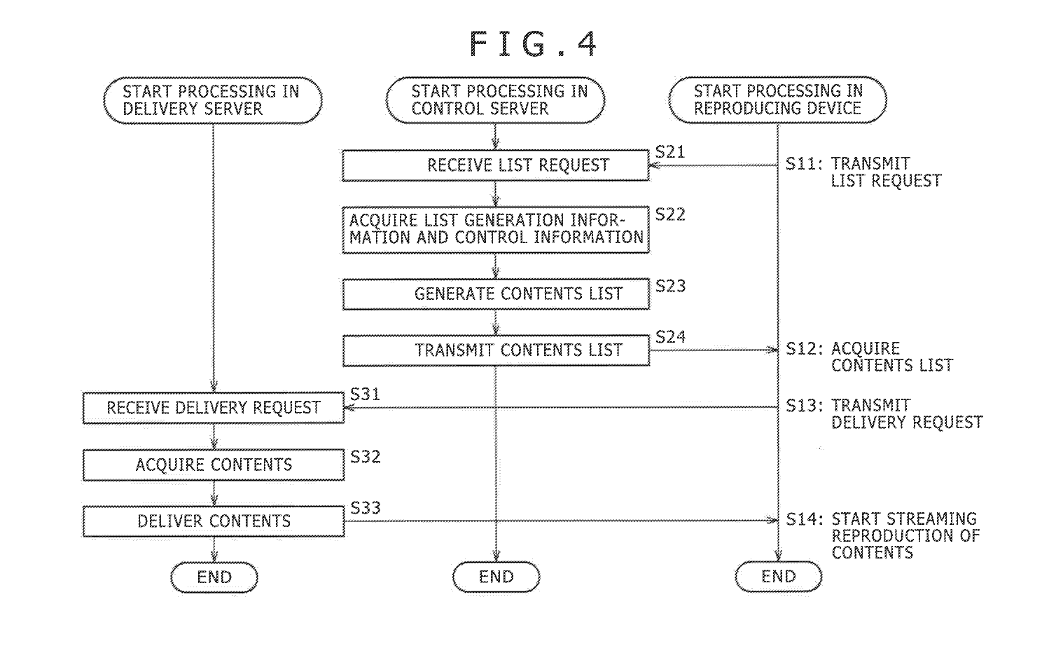

Next, contents delivering processing which is executed by both of the control server 10 and the delivery server 20 will be described with reference to a flow chart shown in FIG. 4.

When the streaming reproduction of the contents is reproduced in the reproducing device 40, the contents to be delivered need to be selected from the contents list. Therefore, a list request for acquisition of the contents list is transmitted from the reproducing device 40 to the control server 10 (Step S11).

When the list request for the contents is transmitted from the reproducing device 40 to the control server 10, in the control server 10, the communication portion 12 receives the list request concerned in accordance with the control made by the control portion 11 (Step S21).

In processing in Step S22, the contents list generating portion 13 acquires both of list generation information and control information which meet the list request concerned from the contents database 30 in accordance with the control made by the control portion 11.

In processing in Step S23, the contents list generating portion 13 generates contents list based on both of the list generation information and control information thus acquired.

In processing in Step S24, the communication portion 12 transmits the contents list generated in the contents list generating portion 13 to the reproducing device 40 through the network 2.

As a result, the contents list is acquired in the reproducing device 40 (Step S12). Also, when in the reproducing device 40, the desired contents are selected from the contents list by a user, a delivery request for the desired contents thus selected is transmitted to the delivery server 20 (Step S13).

When the delivery request is transmitted from the reproducing device 40 to the delivery server 20, in the delivery server 20, the contents delivering portion 22 receives the delivery request in accordance with the control made by the control portion 21 (Step S31).

In processing in Step S32, the contents acquiring portion 23 acquires the contents meeting the delivery request concerned from the contents database 30 in accordance with the control made by the control portion 21.

In processing in Step S33, the contents delivering portion 22 streaming-delivers the contents which have been acquired from the contents acquiring portion 23 to the reproducing device 40 through the network 2 in accordance with the control made by the control portion 21.

As a result, the reproducing device 40 receives the stream data which has been streaming-delivered from the delivery server 20, thereby starting the streaming reproduction of the contents (Step S14).

The contents delivering processing has been described so far.

### [Contents Reproducing Processing]

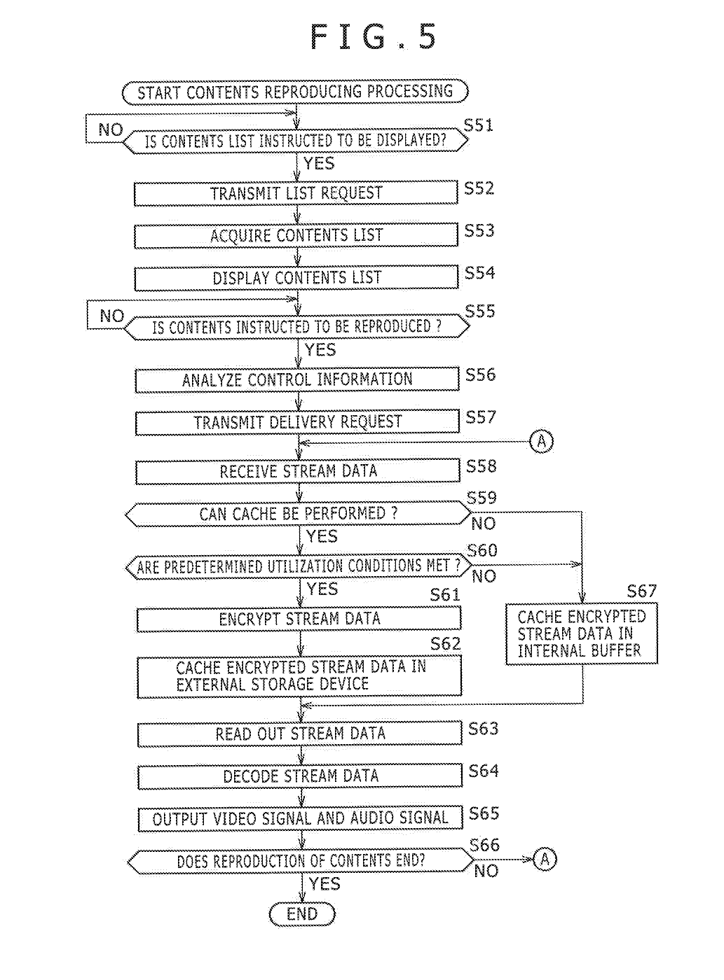

Next, contents reproducing processing which is executed in the reproducing device 40 will be described with reference to a flow chart shown in FIG. 5. It is noted that the contents reproducing processing shown in FIG. 5 corresponds to processing in which the processing executed in the reproducing device 40 and described above in FIG. 4 is shown in more detail.

In processing in Step S51, the control portion 41 determines whether or not the display of the contents list is instructed by the user in accordance with the manipulation signal supplied from the manipulation portion 42. Also, an operation proceeds to processing in Step S52 after the display of the contents list has been instructed by the user.

In processing in Step S52, the communication controlling portion 71 transmits the list request to the control server 10 by controlling the communication portion 43 in response to this, the control server 10 generates the control lists so as to meet the list request made from the reproducing device 40, and transmits the control lists thus generated to the reproducing portion 40.

In processing in Step S53, the communication controlling portion 71 acquires the contents list from the control server 10 by controlling the communication portion 43.

In processing in Step S54, the reproduction controlling portion 72 causes the output portion 50 to display the contents list acquired by the communication controlling portion 71 by controlling the reproducing portion 49.

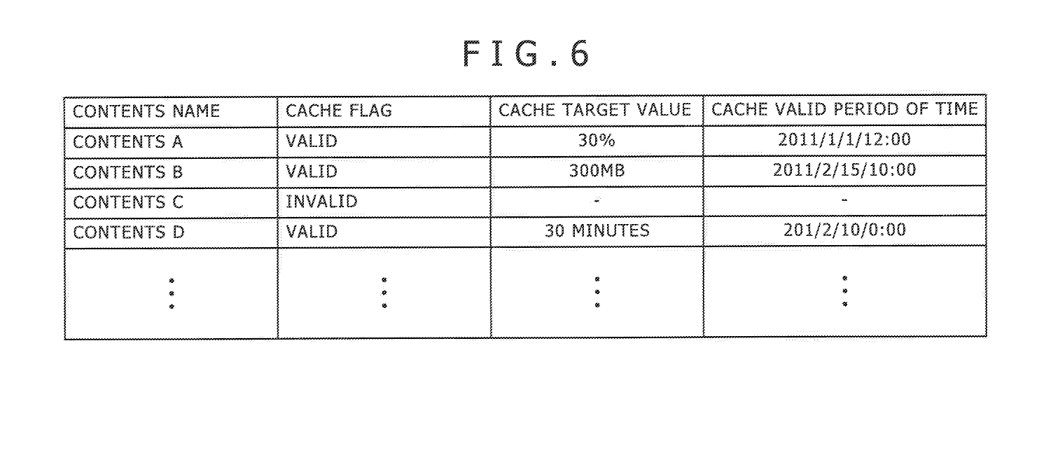

FIG. 6 is a diagram showing an example of the contents list.

As shown in FIG. 6, in the contents list, a cache flag, a cache target value, and a cache valid period of time as three pieces of control information are made to correspond to one another every contents which can be reproduced in the reproducing device 40.

Here, the cache flag is information representing whether or not the cache of the stream data on the contents in the external storage device 60 is allowed. For example, when the cache flag represents the validity, the cache of the stream data on the contents in the external storage device 60 is allowed. On the other hand, when the cache flag represents the invalidity, the cache of the stream data on the contents in the external storage device 60 is rejected. That is to say, in the example shown in FIG. 6, it is possible to cache each of the contents A, B, and D in the external storage device 60. On the other hand, it may be impossible to cache the contents C in the external storage device 60.

In such a manner, the setting of the cache flag is carried out on the service provider 3 side, whereby, for example, the case where the stream data is undesired to be cached in the external storage device 60 is also supposed in terms of the operation depending on the service provider 3. In such a case, by only setting the cache flag to the invalidity, it is possible to limit the cache in the external storage device 60 by the reproducing device 40.

In addition, the cache target value is information representing a target value of the stream data which is cached in the external storage device 60. A ratio of an amount of data which can be cached in the external storage device 60 to an amount of data on the entire contents, an amount of data on the contents which can be cached in the external storage device 60, an amount of data for a reproduction time of the contents which can be cached in the external storage device 60, or the like, for example, is set in the cache target value. That is to say, in the example shown in FIG. 6, in the contents A, a ratio of 30% of the amount of data to the amount of data on the entire contents becomes the target value. In the contents B, the amount of data of 300 MB becomes the target value. Also, in the contents D, the amount of data for the reproduction time of 30 minutes becomes the target value.

The setting of the cache target value is carried out on the service provider 3 side in such a manner, whereby, for example, the allowable range of the amount of stream data which is cached in the external storage device 60 connected to the reproducing device 40 can be controlled in correspondence to the operation which is carried out in the service provider 3. For example, in the case where the operation for the streaming delivery of the contents is carried out, when the stream data for one piece of contents is cached in the external storage device 60, this case is not preferable in terms of the operation because this case becomes equal to the case where the contents are downloaded. In such a case, by setting the cache target value, it is possible to limit an amount of stream data which is cached in the external storage device 60.

In addition, the cache valid period of time is information representing a valid period of time of the stream data cached in the external storage device 60. Time information such as the absolute date and time or a relative time from certain reference time, for example, is set in the cache valid period of time. That is to say, in the example shown in FIG. 6, “2011/1/1/12:00,” “2011/2/15/10:00,” and “2011/2/10/0:00” are set as the valid periods of time in the contents A, B, and D, respectively. When those absolute date and times have elapsed, the stream data, on the corresponding contents, stored in the external storage device 60 is deleted.

The setting of the cache valid period of time is carried out on the service provider 3 side in such a manner, whereby, for example, there is supposed the case as well where the stream data cached in the external storage device 60 is desired to be limited to a given intended use such as the case where the stream data cached in the external storage device 60 is undesired to be reproduced in any of other reproducing devices in terms of the operation. However, the embodiment of the present disclosure can cope with such a case. That is to say, by only setting the cache valid period of time, the stream data for which the cache valid period of time has elapsed can be deleted from the external storage device 60. Therefore, the stream data which has been cached can be limited, to the given intended use.

Note that, in the example shown in FIG. 6, there is shown an example in which the pieces of control information are allocated in increments of contents. However, the pieces of control information may also be allocated in increments of services or channels of the contents delivery service by the service provider 3.

In addition, in the processing in Step S54, only a name of the contents, for example, is displayed in the contents list which is displayed on the output portion 50, and the control information such as the cache flag is internally held. Also, when the desired contents are selected from the contents list concerned, the control information corresponding to the desired contents is acquired by the control information analyzing portion 73.

Moreover, in the processing in Step S54, the reproduction controlling portion 72, for example, may cause a predetermined icon to be displayed for the cacheable contents in accordance with the control information contained in the contents list, whereby the cacheable contents may be displayed so as to be discriminable from any of the contents other than the cacheable contents.

It is noted that although for the sake of simplicity of the description, the description is given on the assumption that the control information is transmitted in the state in which it is contained in the contents list, actually, the control information, for example, is described based on Abstract Syntax Notation One (ASN.1) or Extensible Markup Language (XML), and is distributed through a secure communication. As far as a method of securely distributing the control information, for example, it is possible to utilize a communication using Transport Layer Security (TLS), a communication made through a Key Distribution Center (KDC), or the like.

Referring back to the flow chart shown in FIG. 5, in the processing in Step S55, the control portion 41 determines whether or not the reproduction of the desired contents is instructed from the contents list being displayed by the user based on the manipulation signal supplied thereto from the manipulation portion 42. Also, the operation proceeds to processing in Step S56 after the reproduction of the desired contents has been instructed from the user.

In the processing in Step S56, the control information analyzing portion 73 acquires the control information corresponding to the desired contents which are instructed to be reproduced, and analyzes the control information thus acquired.

In processing in Step S57, the communication controlling portion 71 transmits the delivery request for the desired contents to the delivery server 20 by controlling the communication portion 43. In response to the delivery request, the delivery server 20 acquires the contents meeting the delivery request made from the reproducing device 40, and starts the streaming delivery of the contents concerned.

In processing in Step S58, the communication portion 43 receives the stream data on the contents which have been delivered from the delivery server 20 in accordance with the control made by the communication controlling portion 71.

In processing in Step S59, the storage controlling portion 74 determines whether or not the stream data can be cached in the external storage device 60 based on the analysis results in the processing in Step S56. In this case, whether or not the cache can be carried out is determined depending on whether or not the cache flag of the desired contents which are stored in the contents list of FIG. 6 and which are instructed to be reproduced is valid.

When it is determined in Step S59 that the cache can be carried out, the operation proceeds to processing in Step S60.

In the processing in Step S60, the storage controlling portion 74 determines whether or not the desired contents which are stored in the contents list of FIG. 6 and which are instructed to be reproduced meet predetermined utilization conditions. As far as the utilization conditions, for example, the various kinds of conditions such as the valid period of time for which the contents can be utilized are set on the service provider 3 side. Also, in the determination processing in Step S60, for example, it is determined whether or not the desired contents instructed to be reproduced are the contents, within the valid period of time, which are previously decided.

For example, the cache of the streaming data in the external storage device 60 is usually permitted and the reproduction of the contents is controlled by using Digital Rights Management (DRM) depending on the services provided by the service provider 3 in some cases. In such cases, in the reproducing device 40, the utilization conditions are given the priority over the analysis results about the cache flag, and the control for the reproduction of the contents is made. On the other hand, the reproduction of the contents is controlled without using the DRAM depending on the services provided by the service provider 3 in some cases. In such cases, in the reproducing device 40, the cache of the stream data in the external storage device 60 is controlled on the assumption that the analysis results about the cache flag are given preference and thus the utilization conditions are met.

When it is determined in Step S60 that the predetermined utilization conditions are met, the operation proceeds to processing in Step S61. It is noted that at this time, the storage controlling portion 74 controls the selector 44 such that the stream data supplied from the communication portion 43 is supplied to the encrypting portion 46.

In the processing in Step S61, the encrypting portion 46 encrypts the stream data from the communication portion 43 in accordance with the predetermined encrypting method. In this case, any encrypting method may be adopted as long as the encryption is one which can be encrypted only in the reproducing device 40, for example, the encryption is carried out by using a key inherent in a terminal.

In processing in Step S62, the encrypting portion 46 caches the encrypted stream data which has been encrypted in the processing in Step S61 in the external storage device 60 through the external I/F 47 in accordance with the control made by the storage controlling portion 74. It is noted that when the stream data which was cached last time remains in the external storage device 60, the storage controlling portion 74 makes the control such that after the stream data concerned is deleted, the cache of the encrypted stream data in the external storage device 60 is started.

That is to say, the external storage device 60, so to speak, is utilized as a buffer, whereby the encrypted stream data is cached in the external storage device 60, and the pieces of encrypted stream data thus cached are successively read out in correspondence to a reproduction speed for the contents. In addition, since the stream data cached in the external storage device 60 is previously encrypted, if the external storage device 60 in which the stream data was cached is detached from the reproducing device 40, and is then brought out to the outside, it may be impossible to reproduce the stream data as long as the encryption is broken. Therefore, it is possible to enhance the secret property of the data.

In processing in Step S63, the encrypting portion 46 reads out the encrypted stream data cached in the external storage device 60 in accordance with the control made by the storage controlling portion 74. Also, the encrypting portion 46 decodes the encrypted stream data which was encrypted in Step S61 in accordance with the decoding method corresponding to the encrypting method.

In processing in Step S64, the decoder 48 decodes the stream data supplied thereto from the encrypting portion 46.

In processing in Step S65, the reproducing portion 49 outputs the video signal supplied thereto from the decoder 48 to the output portion 50 such as the display device, thereby displaying the video corresponding to the video signal on the output portion 50. In addition, the reproducing portion 49 outputs the audio signal supplied thereto from the decoder 48 to the output portion 50 such as the speaker, thereby outputting the sound corresponding to the audio signal from the output portion 50. As a result, the streaming reproduction of the contents delivered from the delivery server 20 is carried out.

In processing in Step S66, the control portion 41 determines whether or not the reproduction of the contents being streaming-reproduced ends. When it is determined in Step S56 that the reproduction of the contents being streaming-reproduced does not yet end, the operation returns back to the processing in Step S58, and the predetermined pieces of processing in and after the processing in Step S58 are repetitively executed. In such a manner, when it is determined in Step S59 that the cache can be performed and it is also determined in Step S60 that the predetermined utilization conditions are met, the stream data is cached in the external storage device 60 having the sufficient capacity. Therefore, even when the internal buffer 45 does not have the sufficient capacity, the contents can be stably streaming-reproduced.

On the other hand, either when it is determined in Step S59 that it may be impossible to perform the cache or when it is determined in Step S60 that the predetermined utilization conditions are not met, the operation proceeds to processing in Step S67.

In processing in Step S67, the storage controlling portion 74 controls the selector 44 such that the stream data from the communication portion 43 is supplied to the internal buffer 45, thereby caching the stream data in the internal buffer 45. Also, the decoder 48 reads out the stream data cached in the internal buffer 46 and then decodes the stream data thus read out. As a result, the video signal and the audio signal which are obtained through the reproduction in the reproducing portion 49 are outputted to the output portion 50, and the video corresponding to the video signal and the sound corresponding to the audio signal are displayed on and outputted from the output portion 50.

That is to say, when it is determined that it may be impossible to cache the stream data in the external storage device 50 in accordance with the analysis results about the control information and or like, in the reproducing device 40, the streaming reproduction of the contents is carried out by utilizing the internal buffer 45.

It is noted that when it is determined in Step S66 that the reproduction of the contents ends, the operation ends. In addition, when the contents are normally reproduced, the storage controlling portion 74 deletes the streaming data cached in the external storage device 60.

The contents reproducing processing has been described so far. In such contents reproducing processing, the stream data is cached in the external storage device 60 in accordance with the analysis results about the control information and the like. Also, the contents are streaming-reproduced based on the stream data read out from the external storage device 60. As a result, even with the reproducing device 40 which does not have the internal buffer 45 having the sufficient capacity, the contents can be stably streaming-reproduced by utilizing the external storage device 60 which is detachably connected as the buffer to the reproducing device 40.

In addition, in the case where the network 2 is the Internet, when a line which is thin in an area, or a line in which although there is a sufficient band, the band is largely changed depending on a time zone is utilized, in the case of the receiver which does not have the internal buffer having the sufficient capacity, it may be impossible to absorb the jitter in the Internet, and thus the rebuffering is generated. On the other hand, with the reproducing device 40, since the external storage device 60 which is detachably connected to the reproducing device 40 can be utilized as the buffer, it is possible to suppress the rebuffering.

The external storage device which is detachably connected to the reproducing device is utilized as the buffer in such a manner, whereby the contents can be stably reproduced without depending on the communication environment, and the performance of the receiver. As a result, for example, even with the receiver which is inferior in the performance of the hardware, it becomes possible to streaming-reproduce the contents having the high definition (HD) image quality.

[Contents Reproducing Processing when Cache Target Value is Set]

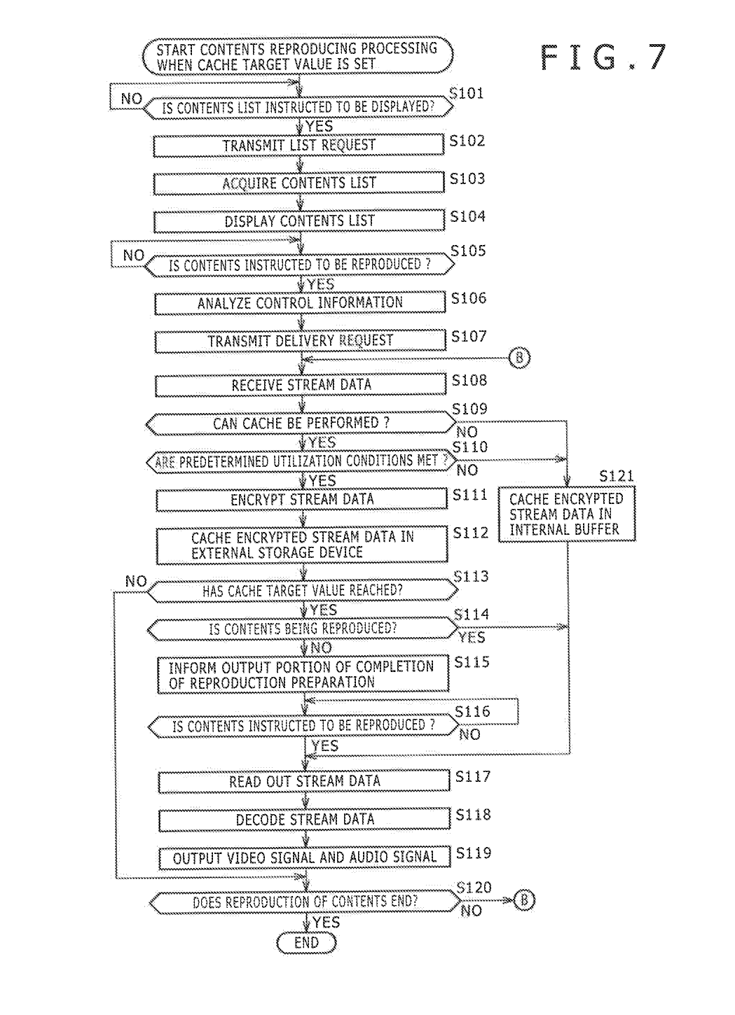

Next, contents reproducing processing when the cache target value is set which is executed by the reproducing device 40 will be described with reference to a flow chart shown in FIG. 7.

In 12 pieces of processing from Step S101 to Step S112, similarly to the case of 12 pieces of processing from Step S51 to Step S62, when the desired contents are selected from the contents list, the reception of the stream data of the contents thus selected is started. Also, the encrypted stream data is cached in the external storage device 60.

In processing in Step S113, the storage controlling portion 74 determines whether or not an amount of stream data cached in the external storage device 60 has reached the predetermined cache target value by usually monitoring the external storage device 60 through the external I/F 47. When it is determined in Step S113 that the amount of stream data cached in the external storage device 60 has not reached the predetermined cache target value, six pieces of processing from Step S114 to Step S119 are skipped, and the operation proceeds to processing in Step S120. Also, when it is determined in Step S120 that the reproduction of the contents has not ended (No: Step S120), the operation returns back to the processing in Step S108, and the predetermined pieces of processing in and after the processing in Step S108 are repetitively executed.

After that, the five pieces of processing from Step S108 to Step S112 are repetitively executed. Thus, an amount of data cached in the external storage device 60 is increased. Then, when it is determined in Step S113 that an amount of data cached in the external storage device 60 has reached the cache target value, the operation proceeds to the processing in Step S114.

In processing in Step S114, the reproducing controlling portion 72 determines whether or not the streaming reproduction of the contents has already been started. When it is determined in Step S114 that the streaming reproduction of the contents has not been started yet, the operation proceeds to processing in Step S115.

In processing in Step S115, the reproduction controlling portion 72 causes the reproducing portion 49 to inform the output portion 50 of the effect that the reproduction preparation has been completed in accordance with the monitoring results from the storage controlling portion 74 by controlling the reproducing portion 49. As far as this informing method, for example, a picture representing the effect that the reproduction preparation has been completed is displayed in the form of pop-up, or a predetermined sound is outputted, thereby informing the user of the completion of the reproduction preparation.

When the output portion 50 has been informed of the completion of the reproduction preparation, the operation proceeds to processing in processing in Step S116. In Step S116, the control portion 41 determines whether or not the desired contents are instructed to be reproduced by the user in response to the information of the completion of the reproduction preparation in accordance with the manipulation signal supplied thereto from the manipulation portion 42. Also, the operation proceeds to processing in Step S117 after the desired contents are instructed to be reproduced by the user.

In three pieces of processing from Step S117 to Step S119, similarly to three pieces of processing from Step S63 to Step S65, the stream data cached in the external storage device 60 is read out and is then decoded, thereby streaming-reproducing the contents.

It is noted that although in the above case, the description has been given such that after the information of the completion of the reproduction preparation, the user is caused to select whether or not the reproduction of the contents is started, when the amount of stream data has reached the cache target value, the streaming reproduction of the contents may be immediately started. In addition, since when the streaming reproduction of the contents is started, in the loop of 13 pieces of processing from Step S108 to Step S120 in and after the processing in Step S108, it is determined that the contents are being reproduced (Yes: Step S114) and two pieces of processing in Step S115 and 116 are skipped, the information of the completion of the reproduction preparation is not carried out again.

Also, when it is determined in Step S120 that the reproduction of the contents has ended, the operation ends. It is noted that the processing for caching the stream data in the internal buffer 45 (Step S121) either when it is determined in Step S109 that it may be impossible to perform the cache or when it is determined in Step S110 that the predetermined utilization contents are not met is the same as that in the processing in Step S67 shown in FIG. 5.

The contents reproducing processing when the cache target value is set has been described so far. In such contents reproducing processing, the stream data cached in the external storage device 60 is usually monitored, and when the amount of stream data cached in the external storage device 60 has reached the predetermined cache target value, the user is informed of that effect. Therefore, the user can carry out other works by executing other programs without being aware of the cache processing for the stream data which is executed in the background until the reproduction preparation has been completed. In addition, since even in carrying out such a work(s), the user is informed of the completion of the reproduction preparation, it is possible to reliably view the streaming reproduction of the desired contents.

### [Data Deleting Processing Corresponding to Cache Valid Period of Time]

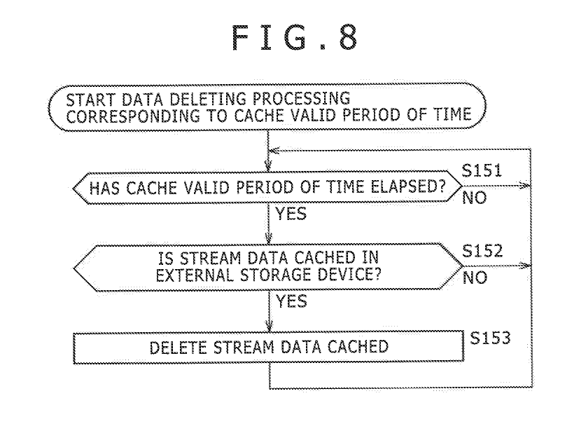

Next, data deleting processing corresponding to the cache valid period of time and executed in the reproducing device 40 will be described with reference to a flow chart shown in FIG. 8.

In processing in Step S151, the control information analyzing portion 73 analyzes the control information corresponding to the stream data on the contents cached in the external storage device 60 and determines whether or not the cache valid period of time of the stream data concerned has elapsed. When it is determined in Step S151 that the cache valid period of time of the stream data concerned has elapsed, the operation proceeds to processing in Step S152.

In processing in Step S152, the storage controlling portion 74 determines whether or not the stream data on the contents for which the cache valid period of time of the stream data concerned has elapsed is cached in the external storage device 60 by monitoring the external storage device 60 through the external I/F 47. When it is determined in Step S152 that the stream data on the contents for which the cache valid period of time of the stream data concerned has elapsed is cached in the external storage device 60, the operation proceeds to processing in Step S153.

In processing in Step S153, the storage controlling portion 74 deletes the stream data cached in the external storage device 60 by accessing the external storage device 60 through the external I/F 47. As a result, the stream data on the contents for which the cache valid period of time has elapsed is forcibly deleted.

It is noted that either when it is determined in Step S151 that the cache valid period of time has not elapsed yet, or when it is determined in Step S152 that the stream data on the contents for which the cache valid period of time has elapsed is not cached in the external storage device 60, the operation returns back to the processing in Step S151, and two pieces of determination processing in Step S151 and Step S152 are repetitively executed.

The data deleting processing corresponding to the cache valid period of time has been described so far. In such data deleting processing, the data stream being cached in the external storage device 60 is deleted in correspondence to the cache valid period of time. Therefore, for example, it becomes possible to carry out the operation for prohibiting the data stream cached in the external storage device 60 from being reproduced in any of other reproducing devices.

The reproducing device 40 utilizes the external storage device 60 as the buffer in the manner as described above, whereby the contents delivered from the delivery service 20 can be stably streaming-reproduced without depending on the communication environment in the case where the band of the network 2 is unstable or the like, and the terminal performance such as the capacity of the internal buffer 45.

In general, as compared with the recent progress of the service in the Internet, it takes time to maintain the communication environment. For example, however, even when the reproducing device 40 is used in an area in which the communication environment is not put into place, the external storage device 60 is utilized as the buffer, whereby it is possible to stably carry out the streaming reproduction. In addition, in the future also, it is expected that along with the progress of the service, the capacity of the contents delivered is more and more increased. For example, however, even in the case of the reproducing device 40 which was purchased some years earlier, the external storage device 60 is utilized as the buffer, whereby the performance of the reproducing device 40 concerned is compensated for, and thus it is possible to stably carry out the streaming reproduction.

In addition, the control information which is consolidated in the service provider 3 is provided to the reproducing device 40, and the reproducing device 40 in turn controls the cache of the stream data in the external storage device 60 based on the control information thus acquired. Therefore, it is unnecessary for the reproducing device 40 to hold the control information. For this reason, the reproducing device 40 need not control the governance for each service, and the governance in units of contracts. As a result, since the reproducing device 40 need not hold a license of Digital Rights Management (DRM), and a DRM object in the inside thereof, it is possible to save the system resource. Therefore, for example, it is unnecessary to increase any of the excessive memories in the reproducing device 40. In addition, since the control information is consolidated in the service provider 3, the contents thereof can be dynamically changed.

It is noted that the reproducing device 40 can be applied to electronic apparatuses, in all of the fields, such as a receiver in an IPTV, a personal computer, a tablet type computer, and a personal digital assistance such as a mobile phone or a smartphone. In other words, the reproducing device 40 can be applied to electronic apparatuses in all of the fields each of which can reproduce the contents streaming-delivered.

In addition, although in the above explanation, the description has been given with respect to the case where the control server 10 and the delivery server 20 are configured in the form of the separate servers every function provided, all of or a part of these functions may be collected so as to be provided by one server, or two or more servers.

[Description of Computer to which the Present Disclosure is Applied]

The series of processing described above can be executed either by hardware or by software. When the series of processing is executed by the software, a program composing the software is installed in a computer. Here, the computer, for example, includes a computer incorporated in dedicated hardware, and a general-purpose personal computer which can execute various kinds of functions by installing therein various kinds of programs.

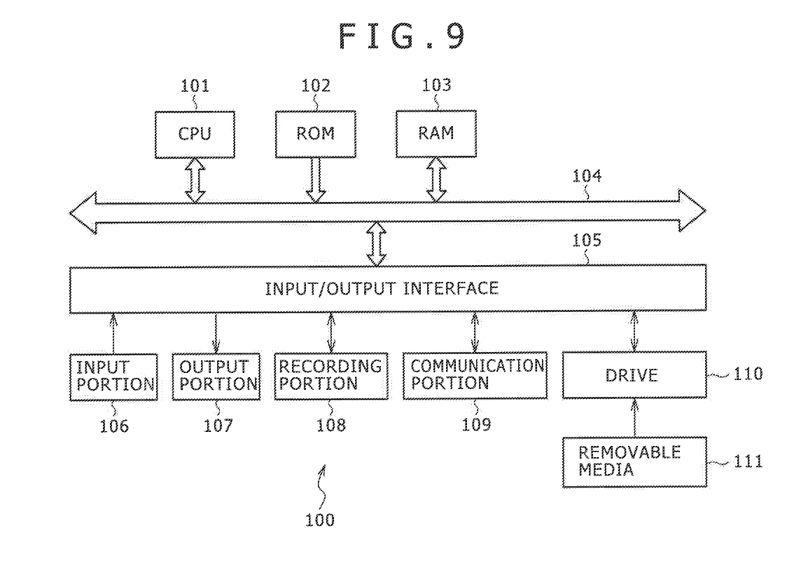

FIG. 9 is a block diagram showing a configuration of hardware of a computer for executing the series of processing described above in accordance with a program.

In the computer, a Central Processing Unit (CPU) 101, a Read Only Memory (ROM) 102, and a Random Access Memory (RAM) 103 are connected to one another through a bus 104.

An input/output interface 105 is further connected to the bus 104. An input portion 106, an output portion 107, a recording portion 108, a communication portion 109, and a drive 110 are connected to the input/output interface 105.

The input portion 106 is composed of a keyboard, a mouse, a microphone, or the like. The output portion 107 is composed of a display device, a speaker, or the like. The recording portion 108 is composed of a hard disc, a non-volatile memory, or the like. The communication portion 109 is composed of a network interface or the like. The drive 110 drives a removable media 111 such as a magnetic disc, an optical disc, a magneto optical disc, or a semiconductor memory.

With the computer 100 configured in the manner as described above, for example, the CPU 101 loads the program stored in the recording portion 108 into the RAM 103 through the input/output interface 105 and the bus 104 in order to execute the program, thereby executing the series of processing described above.

The program which the computer 100 (the CPU 101) executes, for example, can be recorded in the removable media 111 as a package media or the like to be provided. In addition, the program can be provided through a wired or wireless transmission media such as a Local Area Network (LAN), the Internets, or the digital satellite broadcasting.

In the computer 100, the program can be installed in the recording portion 108 through the input/output interface 105 by mounting the removable media 111 to the drive 110. In addition, the program can be received at the communication portion 109 through the wired or wireless transmission media to be installed in the recording portion 108. In addition thereto, the program can be previously installed either in the ROM 102 or in the recording portion 108.

It is noted that the program which the computer 100 executes either may be a program in accordance with which predetermined pieces of processing are executed in a time series manner along the order described in this specification, or may be a program in accordance with which the predetermined pieces of processing are executed in parallel or at a necessary timing such as when a call is made.

Here, in this specification, the processing steps describing the program in accordance with which the computer 100 is caused to execute the various kinds of processing are not unnecessarily processed in a time series manner along the order which is described as the flow chart. Thus, the processing steps concerned includes processing (for example, parallel processing or processing executed by an object) which is executed either in parallel or individually.

In addition, the program either may be one which is processed by one computer, or may be one which is dispersively processed by plural computers. Moreover, the program may also be one which is transferred to a faraway computer and is then executed by the faraway computer.

Moreover, in this specification, the system means a set of plural constituent elements (such as apparatuses or modules (components or parts)), and it is no object whether or not all of the constituent elements are provided within the same chassis. Therefore, plural apparatuses which are accommodated in different chassis, and which are connected to one another through a network, and one apparatus in which plural modules are accommodated in one chassis are each the system.

It is noted that the embodiment(s) of the present disclosure is(are) by no means limited to the embodiment described above, and the various kinds of changes can be made without departing from the subject matter of the present disclosure.

For example, the present disclosure can adopt a configuration of cloud computing in which one function is shared among plural apparatuses or devices through a network, and plural apparatuses or devices cooperatively execute one function through the network.

Also, the steps described with reference to the flow chart described above not only can be executed by one apparatus or device, but also can be shared among plural apparatuses or devices to be executed.

In addition, when plural pieces of processing are contained in one step, plural pieces of processing contained in one step not only can be executed by one apparatus or device, but also can be shared among plural apparatuses or devices.

It is noted that the present disclosure can adopt the following constitutions.

(1) A reproducing device including: an acquiring portion acquiring stream data on contents which are streaming-delivered through a network in which a band is changed; a storage control portion controlling temporary storage of the stream data thus acquired in an external storage device detachably connected; and a reproducing portion reproducing the contents based on the stream data read out from the external storage device.

(2) The reproducing device described in the paragraph (1), further including:

a control information analyzing portion acquiring control information in accordance with which storage of the stream data set on a side of delivery of the contents in the external storage device is controlled, and analyzing the control information,

in which the storage controlling portion causes the external storage device to store therein the stream data based on an analysis result about the control information.

(3) The reproducing device described in the paragraph (2), in which the control information contains therein information representing whether or not the storage of the stream data in the external storage device is allowed; and

when the storage of the stream data in the external storage device is allowed, the storage controlling portion causes the external storage device to store therein the stream data.

(4) The reproducing device described in the paragraph (2) or (3), in which the control information contains therein information representing a target value of the stream data stored in the external storage device; and

when the stream data stored in the external storage device reaches the target value, the reproducing portion reproduces the contents based on the stream data read out from the external storage device.

(5) The reproducing device described in the paragraph (4), further including:

an information portion, when the stream data stored in the external storage device reaches the target value, informing that the stream data reaches the target value.

(6) The reproducing device described in any one of the paragraphs (2) to (5), in which the control information contains therein information representing a valid period of time of the stream data stored in the external storage device; and

when the valid period of time of the stream data elapses, the storage controlling portion deletes the stream data stored in the external storage device.

(7) The reproducing device described in the paragraph (2), in which the control information analyzing portion acquires the control information before the acquisition of the stream data is started.

(8) The reproducing device described in the paragraph (1), further including:

an encrypting portion encrypting the stream data stored in the external storage device.

(9) A reproducing method for use in a reproducing device including:

acquiring stream data on contents which are streaming-delivered through a network in which a band is changed by the reproducing device;

controlling temporary storage of the stream data thus acquired in an external storage device detachably connected by the reproducing device; and

reproducing the contents based on the stream data read out from the external storage device by the reproducing device.

(10) A program in accordance with which a computer is caused to function as:

an acquiring portion acquiring stream data on contents which are streaming-delivered through a network in which a band is changed;

a storage control portion controlling temporary storage of the stream data thus acquired in an external storage device detachably connected; and

a reproducing portion reproducing the contents based on the stream data read out from the external storage device.

The present application contains subject matter related to that disclosed in Japanese Priority Patent Application JP 2012-009585 filed in the Japan Patent Office on Jan. 20, 2012, the entire content of which is hereby incorporated by reference.

What is claimed is:

1. A reproducing device, comprising:
an acquiring portion acquiring stream data on contents which are streaming-delivered through a network in which a band is changed;
a storage control portion controlling temporary storage of the stream data thus acquired in an external storage device detachably connected; and
a reproducing portion reproducing the contents based on the stream data read out from said external storage device.

2. The reproducing device according to claim 1, further comprising:
a control information analyzing portion acquiring control information in accordance with which storage of the stream data set on a side of delivery of the contents in said external storage device is controlled, and analyzing the control information,
wherein said storage controlling portion causes said external storage device to store therein the stream data based on an analysis result about the control information.

3. The reproducing device according to claim 2, wherein the control information contains therein information representing whether or not the storage of the stream data in said the external storage device is allowed; and
when the storage of the stream data in said external storage device is allowed, said storage controlling portion causes said external storage device to store therein the stream data.

4. The reproducing device according to claim 2 wherein the control information contains therein information representing a target value of the stream data stored in said external storage device; and
when the stream data stored in said the external storage device reaches the target value, said reproducing portion reproduces the contents based on the stream data read out from said external storage device.

5. The reproducing device according to claim 4, further comprising:
an information portion, when the stream data stored in said external storage device reaches the target value, informing that the stream data reaches the target value.

6. The reproducing device according to claim 2, wherein the control information contains therein information representing a valid period of time of the stream data stored in said external storage device; and
when the valid period of time of the stream data elapses, said storage controlling portion deletes the stream data stored in said external storage device.

7. The reproducing device according to claim 2, wherein said control information analyzing portion acquires the control information before the acquisition of the stream data is started.

8. The reproducing device according to claim 1, further comprising
an encrypting portion encrypting the stream data stored in said external storage device.

9. A reproducing method for use in a reproducing device, comprising:
acquiring stream data on contents which are streaming-delivered through a network in which a band is changed by said reproducing device;
controlling temporary storage of the stream data thus acquired in an external storage device detachably connected by said reproducing device; and
reproducing the contents based on the stream data read out from said external storage device by said reproducing device.

10. A program in accordance with which a computer is caused to function as:
an acquiring portion acquiring stream data on contents which are streaming-delivered through a network in which a band is changed;
a storage control portion controlling temporary storage of the stream data thus acquired in an external storage device detachably connected; and
a reproducing portion reproducing the contents based on the stream data read out from said external storage device.
